(19) United States
(12) Patent Application Publication
(10) Pub. No.: US 2022/0331843 A1
(43) Pub. Date: Oct. 20, 2022

(54) SEAMING ROLLER CLEANER AND METHOD FOR CLEANING SUCH A CLEANER

(71) Applicant: MAGNA Metalforming GmbH, Wien (AT)

(72) Inventor: Patrick Pöschl, Krottendorf-Gaisfeld (AT)

(21) Appl. No.: 17/719,460

(22) Filed: Apr. 13, 2022

(30) Foreign Application Priority Data
Apr. 14, 2021 (DE) 10 2021 203 680.5

(51) Int. Cl. B08B 1/00; B08B 13/00; B21D 51/32

(52) U.S. Cl. CPC B08B 1/006; B08B 1/008; B08B 13/00; B21D 51/32

(57) ABSTRACT

A seaming roller cleaner includes a base body, on which a driven roll receptacle and a non-driven roll receptacle are mounted. The roll receptacles are used to receive paper web rolls. The paper web roll includes a cleaning web, and the base body provides a support over which the cleaning web is laid to define a cleaning surface. The cleaning web is drawn by the driven roll receptacle in the direction of the driven roll receptacle. The non-driven roll receptacle is passively rotated and may be slightly braked to prevent rotating too quickly. The support includes a carrier plate and an elastomer. The seaming roller may be arranged at an oblique angle relative to the direction of the cleaning web is drawn, such that the seaming roller is wiped and slowly rotated by the cleaning web.

### CROSS-REFERENCE TO RELATED APPLICATIONS

This application claims priority to DE 10 2021 203 680.5 filed Apr. 14, 2021. The entire disclosure of the above application is incorporated herein by reference.

### FIELD

The invention relates to a seaming roller cleaner for seaming rollers of a processing machine and a method for cleaning at least one seaming roller.

### BACKGROUND

This section provides information related to the present disclosure which is not necessarily prior art.

The roll-seaming process is used to connect sheet-metal parts to one another in a positive-locking manner. During this process, as a rule, an outer sheet is formed around an inner sheet by a processing tool that is fitted to an industrial robot and has a work roller, referred to as a seaming roller. To increase the strength of the connection, adhesive is often additionally applied between the sheet-metal parts to be joined. During the forming of the sheets with the seaming roller, adhesive may escape from the joint, contaminating the seaming roller both on the running surface and on the end face. When seaming aluminium components, there is the additional risk that an aluminium layer will build up on the contact surface of the seaming rollers.

This contamination of the seaming roller is transferred to the other components, and this causes increased finishing work and cleaning work, which has to be carried out manually. This finishing work is associated with high costs in the production process.

DE 10 2018 101 507 A1 discloses a device for cleaning a processing roller of a processing tool, which is designed, in particular, as a seaming roller of a roller seaming tool. The device has a base body, a rail member, and a cleaning unit, wherein the rail member is connected to the base body and wherein the cleaning unit can be moved in relation to the base body and the rail member in the direction of extent of the rail member. This makes it possible to guide the processing tool over the rail member and, in the process, to follow the processing tool with the cleaning unit. The cleaning unit comprises rotary driving of the processing roller by movement of the processing tool on a path. This makes it possible, in the device for cleaning, to dispense with an active drive for the processing roller of the processing tool.

It is also envisaged that the cleaning unit comprises at least one mechanical cleaning means, which is designed, in particular, as a scraper and which can be moved with the cleaning unit. This construction requires a lot of space and is not easy to maintain.

It is the object of the present disclosure to propose a device for cleaning a seaming roller of a processing tool, wherein the device is to be simplified and optimized.

### SUMMARY

This section provides a general summary of the disclosure, and is not a comprehensive disclosure of its full scope or all of its features.

The object of the present disclosure is achieved by a seaming roller cleaner comprising a base body, on which a driven roll receptacle and a non-driven roll receptacle are mounted, said roll receptacles being used to receive paper web rolls, wherein the paper web roll comprises a cleaning web, and the base body provides a support, over which the cleaning web is laid and can be moved in the direction of the driven roll receptacle.

The construction of the seaming roller cleaner is simple and efficient. The use of an “endless” cleaning web ensures continuous cleaning over a long period of time. Moreover, the cleaning material is easy to replace.

It is advantageous here that the support and the cleaning web provide a cleaning surface on which at least one seaming roller can be cleaned.

It is particularly advantageous if the support is formed by a carrier plate, an elastomer, and the cleaning web. This gives a flexible support, ensuring that no damage occurs when the seaming roller is placed on top. Furthermore, as a result, the seaming roller penetrates to a certain extent, and the cleaning web can operate more efficiently.

In one aspect, sensors monitor both the tearing of the cleaning web and the end of the cleaning web on the paper web roll.

The roll holders are constructed from a cylindrical body having flange discs, one of which flange discs is removable. In this way, the paper web roll can be exchanged in a simple manner by removing one of the flange discs.

In one aspect, the flange discs have driver pins for the paper web roll.

The object of the present disclosure is also achieved by a method for cleaning a seaming roller by means of a seaming roller cleaner, wherein a cleaning web is drawn over a cleaning surface by means of a driven roll holder, wherein at least one seaming roller is placed on the cleaning surface at an angle in relation to the perpendicular to the direction in which the cleaning web is drawn.

It is advantageous here that cleaning is accomplished by wiping and slowly rolling at least one seaming roller.

In one aspect, the at least one seaming roller is placed on the cleaning surface by a robot arm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 shows a section through a seam with a roller,

FIG. 2 shows the seaming roller cleaner according to an aspect of the present disclosure,

FIG. 3 shows a top view of the seaming roller cleaner,

FIG. 4 shows a section A-A′,

FIG. 5 shows a roll receptacle,

FIG. 6 shows a detail in the roll receptacle,

FIG. 7 shows a light barrier.

### DETAILED DESCRIPTION

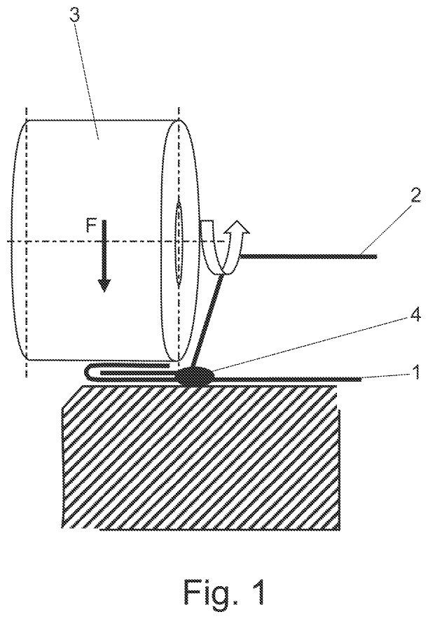

FIG. 1 shows schematically a seaming process involving a first sheet 1 and a second sheet 2, which rests on a seaming bed. A seaming roller 3 exerts a force F on the seam. Adhesive 4 escapes at the separation point between the first sheet 1 and the second sheet 2.

If the seaming roller 3 comes into contact with the adhesive 4, it distributes it to this sheet and to other components.

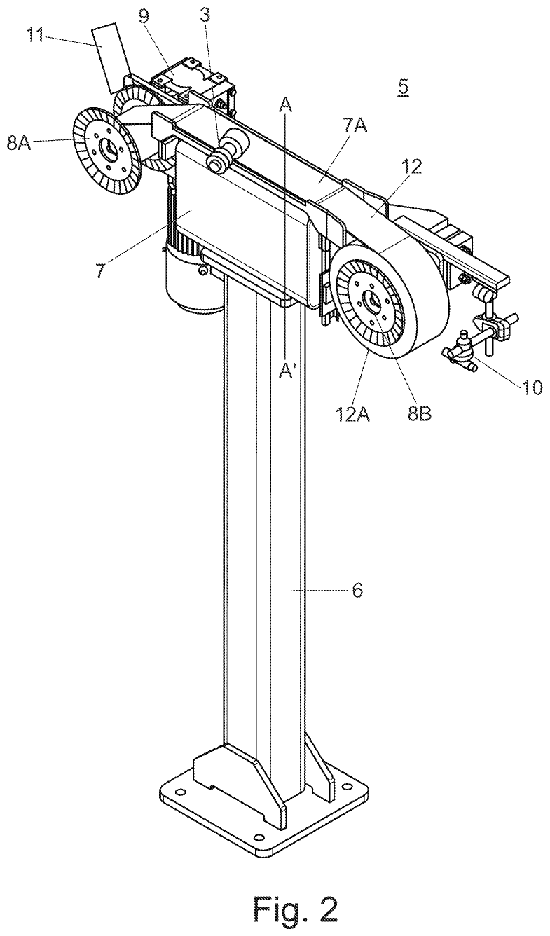

A device of the kind illustrated in FIG. 2 is provided for cleaning the seaming roller 3. The seaming roller cleaner 5 may be a free-standing unit, which has a foot 6 screwed to a machine, such as the seaming machine. Other types of fastening re, of course, also conceivable.

Arranged on the foot 6 is a base body 7, which is in the form of a T top section perpendicular to the foot 6. Roll holders 8A and 8B are rotatably mounted on both sides of the base body 7. Roll holder 8A is connected to a drive 9, which drives roll holder 8A. A sensor, e.g. an optical sensor 11, is mounted on roll holder 8A.

Roll holder 8B, on the other hand, is passively rotatable, not having its own dedicated drive, but is slightly braked to prevent it from being rotated too quickly. In this case, the braking action is adjustable.

A supporting structure or carrier 7B, on which a light barrier 10 is mounted, is present on the base body 7 in the region of roll holder 8B.

A roll consisting of a paper web comprising a cleaning web 12 is slipped onto roll holder 8B as paper web roll 12A. The cleaning web is guided evenly over the upper side 7A of the base body 7. The other end of the paper web is fastened to an empty reel of roll holder 8A and the cleaning web 12 is drawn over the upper side 7A of the base body 7 with the aid of the drive 9.

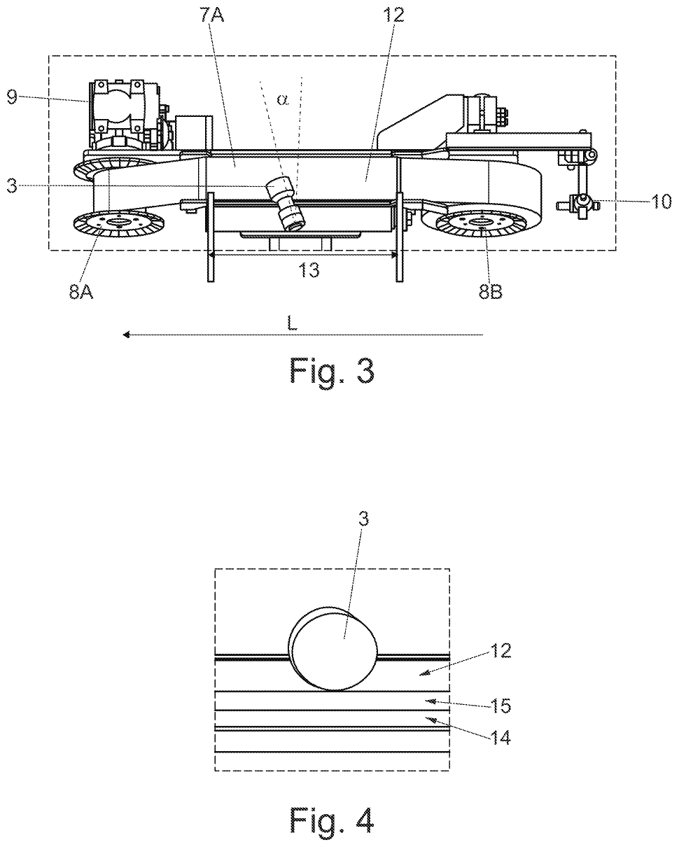

FIG. 3 illustrates in a plan view how the cleaning web 12 rests on the base body 7. The cleaning web 12 rests on the upper side 7A of the base body 7 and forms a region or cleaning surface 13. By way of example, this cleaning surface 13 has dimensions of 300 mm×75 mm. This surface 13 is sufficient to clean one or possibly even a plurality of seaming rollers.

A seaming roller 3 is depicted schematically on the cleaning surface 13. The seaming roller may be moved to the seaming roller cleaner 5 by a robot arm, which is not illustrated, or else manually. The seaming roller 3 is placed on the cleaning web at an oblique angle a in relation to the perpendicular to the longitudinal direction of the cleaning web 12. As a result of the oblique positioning of the seaming roller 3 in the pulling direction, a simultaneous rolling/wiping movement is produced, which cleans the seaming roller 3 as the cleaning web 12 is pulled through the region or cleaning surface 13.

FIG. 4 illustrates a section through the base body 7. The base body 7 is constructed with a carrier plate 14, to which a support plate 15 made of an elastomer 15 is applied. The cleaning web 12 is stretched over this assembly of carrier plate 14 and support plate/elastomer 15. Below the cleaning web 12 is a layer of elastomer 15, which is intended to somewhat dampen the robot movement when the seaming roller 3 is placed on it. This elastomer layer 15 is flexible and the seaming roller 3 may penetrate into it very easily when being placed thereupon.

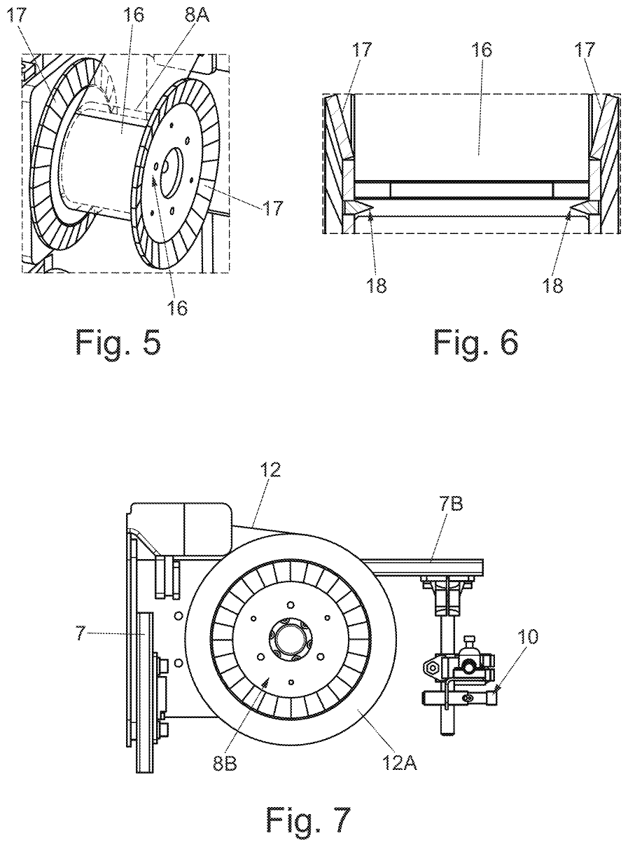

FIG. 5 shows a roll receptacle 8A (or 8B), which is designed as a cylindrical body 16 with laterally attached flange discs 17 for securing the paper web roll 12A. In this case, the flange discs 17 are screwed or latched to the cylindrical body 16 in order to allow simple exchangeability of the rolls 12A of paper web.

FIG. 6 shows, in a sectional view of a roll holder 8A or 8B, flange discs 17 to the left and right of the cylindrical body 16 which carries them. In this case, driver pins 18 are formed, which serve to drive the paper web roll 12A. The driver pins 18 penetrate into the cardboard core of the paper web roll 12A, ensuring that the latter does not slip on the cylindrical body 17.

FIG. 7 shows roll receptacle 8B with the carrier 7B and the light barrier 10 disposed nearby. The light barrier 10 monitors the thickness of the paper web roll, thus enabling a simple inquiry to be made as to when the end of the paper web roll 12A has been reached.

The actively driven roll receptacle 8A is monitored by an optical sensor 11 to determine a possible tape tear of the paper web roll.

The seaming roller cleaner 5 moves the cleaning web 12 over the upper side 7A of the base body 7 in the longitudinal direction L. The seaming roller 3 is placed on the cleaning surface 13 and wiped by the cleaning web 12, rotating very slowly at the same time.

The description and specific examples described and shown above are intended for purposes of illustration and are not intended to limit the scope of the present disclosure or the invention as set forth in the following claims.

What is claimed is:

1. A seaming roller cleaner comprising:
a base body, on which a driven roll receptacle and a non-driven roll receptacle are mounted,
wherein the roll receptacles receive a paper web roll,
wherein the paper web roll comprises a cleaning web,
wherein the base body provides a support, over which the cleaning web is laid and can be moved in the direction of the driven roll receptacle;
wherein the support is formed by a carrier plate and an elastomer, and the cleaning web is disposed on the support.

2. The seaming roller cleaner according to claim 1, wherein the support and the cleaning web provide a cleaning surface on which at least one seaming roller can be cleaned.

3. The seaming roller cleaner according to claim 1, wherein sensors monitor both for tearing of the cleaning web and for the end of the cleaning web on the paper web roll.

4. The seaming roller cleaner according to claim 1, wherein the roll receptacles are constructed from a cylindrical body having flange discs on opposite ends thereof, one of which flange discs is removable for installation and removal of the paper web roll.

5. Seaming roller cleaner according to claim 4, wherein the flange discs of at least one of the roll receptacles have driver pins for engaging the paper web roll.

6. The seaming roller cleaner according to claim 3, wherein the sensors include an optical sensor disposed adjacent the driven roll receptacle to monitor for tears in the paper web roll.

7. The seaming roller cleaner according to claim 6, wherein the sensors include a light barrier disposed adjacent the non-driven roll receptacle to monitor for the end of the paper web roll.

8. The seaming roller cleaner according to claim 1, wherein the non-driven roll receptacle is passively rotated in response to rotation of the driven roll receptacle and a pulling force on the paper web roll, and the non-driven roll receptacle is slightly braked to prevent the non-driven roll receptacle from being rotated too quickly.

9. The seaming roller cleaner according to claim 2, wherein the elastomer is flexible such that the at least one seaming roller at least partially penetrates the support when placed on top of the support.

10. The seaming roller cleaner according to claim 2, wherein the at least one seaming roller is placed on the support at an oblique angle relative to the longitudinal direction, and cleaning web wipes and rotates the at least one seaming roller during cleaning.

11. A method for cleaning a seaming roller by a seaming roller cleaner, the method comprising the steps of:
drawing a cleaning web over a cleaning surface by a driven roll holder in a first direction,
placing at least one seaming roller on the cleaning web at the cleaning surface at an oblique angle relative to the perpendicular to the first direction along which the cleaning web is drawn.

12. The method according to claim 11, wherein the cleaning is accomplished by wiping and slowly rolling at least one seaming roller by the cleaning web.

13. The method according to claim 11, wherein the at least one seaming roller is placed on the cleaning surface robotically.

14. The method according to claim 11, wherein the cleaning web is disposed over an elastomer and a carrier plate, wherein the elastomer and the carrier plate defined a support for the at least one seaming roller.

15. The method according to claim 14, wherein the elastomer is flexible, and the at least one seaming roller at least partially penetrates the support when placed on the cleaning web.

16. The method according to claim 11 wherein a driven roll receptacle is rotated by a drive to draw the cleaning web, wherein a non-driven roll receptacle is passively rotated in response to drawing the cleaning web.

17. The method according to claim 16, further comprising monitoring the paper web roll at the driven roll receptacle for tears via an optical sensor.

18. The method according to claim 17, further comprising monitoring a thickness of the paper web roll at the non-driven receptacle to determine when an end of the paper web roll is reached.

19. The method according to claim 19 further comprising slightly braking the non-driven roll receptacle to prevent the non-driven roll receptacle from being rotated too quickly.
